(19) United States
(12) Patent Application Publication
(10) Pub. No.: US 2016/0046040 A1
(43) Pub. Date: Feb. 18, 2016

(54) SQUEEZING-ROLL GRANULATOR AND USE THEREOF

(71) Applicants: Stefan Dahlheimer, Kleinostheim (DE); Helmuth Meidhof, Grossostheim (DE); Marco Nieder, Messel (DE)

(72) Inventors: Stefan Dahlheimer, Kleinostheim (DE); Helmuth Meidhof, Grossostheim (DE); Marco Nieder, Messel (DE)

(21) Appl. No.: 14/834,060

(22) Filed: Aug. 24, 2015

Related U.S. Application Data
(63) Continuation of application No. PCT/EP2014/000446, filed on Feb. 19, 2014.

(30) Foreign Application Priority Data
Feb. 22, 2013 (DE) 102013003032.3

(51) Int. Cl. B29B 9/06; B01J 2/22

(52) U.S. Cl. CPC B29B 9/06; B01J 2/22; B29K 2101/12

(57) ABSTRACT

A squeeze roller granulator that has a cylindrical pressure roller and a toothed squeeze roller. The gearing of the squeeze roller has tooth flanks that are situated between a tooth root region and a tooth tip region. The tooth root region has an outer diameter that is smaller than the outer diameter of the tooth tip region. The tooth tip region of the squeeze roller has three crushing zones including a middle crushing zone, which define different distances from the cylindrical pressure roller with a minimum distance in the region of the middle crushing zone, and the contour of the tooth flanks and the tooth root region of the crush roller in cooperation with the contour of the cylindrical pressure roller defines a maximum cross-section of granulate cushions to be formed.

### CROSS REFERENCE TO RELATED APPLICATIONS

The present patent application is a Continuation Application that claims priority to and the benefit of co-pending International Patent Application No. PCT/EP2014/000446 filed Feb. 19, 2014, entitled “SQUEEZING-ROLL GRANULATOR AND USE THEREOF”, which claims priority to DE Application No. 102013003032.3 filed Feb. 22, 2013. These references are hereby incorporated in their entirety.

### FIELD

The present embodiments relate to a squeezing roll or squeezing roller granulator, which has a cylindrical pressure roller and a toothed squeezing roller. The teeth of the squeezing roller can have tooth flanks that are situated between a tooth root region and a tooth tip region, and the tooth root region can have an outer diameter that is smaller than the outer diameter of the tooth tip region.

### BACKGROUND

Devices similar to the present invention for granulating strands of plastic material and similar plastic masses are known in the art, such as those from AUTOMATIK APPARATE-MASCHINENBAU GMBH®.

Strands of plastic material and similar plastic masses are referred to below as plastic strands, although not limited to such. In many embodiments, the plastic strands can have a covering tube with an enclosed filling. The squeezing roller device or similar such devices that are known to persons having ordinary skill in the art can have a feeder device for at least one externally hardened strand, which can guide the strand to a roller pair that can be driven in opposite directions around parallel axes.

At least one roller of the roller pair can be made of a material that is hard in comparison to the plastic material and can have projections distributed over its circumference that extend in a substantially axial direction. The outer ends of the squeezing roller extending radially can cooperate with a smooth, cylindrical surface of the pressure roller. In this embodiment, the radial outer surface regions of the projections can almost come to rest against the pressure roller, such that in this position, the roller is held at a stop with a prestressing force and the plastic material of the plastic strand is broken down into granulate.

A disadvantage of existing devices is that they are not able to produce granulate cushions out of covering bags with a filler, as required for different applications in many variations.

For this need, existing publications have disclosed methods and devices that use a coextrusion method in order to produce a multi-layer plastic container out of tubular coextruded plastic materials which are formed into containers. In embodiments, a filling mandrel makes it possible, after the container has been coextruded, to introduce a filler into the coextruded and molded container.

The disadvantage of such existing devices that enable coextruded containers to be subsequently filled by means of a filling mandrel is the complexity of device design. The device must be capable of molding coextruded containers, incrementally filling the containers by means of a filling mandrel, and subsequently closing the container.

The object of the present invention is to create a squeezing roller granulator with a cylindrical pressure roller and a toothed squeezing roller, which is able to produce and seal granulate cushions, which have a covering comprising a portioned filler.

The present embodiments address the issues described above to disclose a device which eliminates the above complications and is able to produce and seal the desired items.

### BRIEF DESCRIPTION OF THE DRAWINGS

The detailed description will be better understood in conjunction with the accompanying drawings as follows:

FIG. 1 shows a schematic diagram of a crush granulator in a granulation system for producing granulate cushions.

FIG. 2 shows a schematic cross-section through a section of a crush granulator.

FIG. 3 shows a schematic perspective view of a squeezing roll of the crush granulator.

FIG. 4 shows a schematic contour of a tooth tip region of a squeezing roll.

FIG. 5 shows a schematic contour of a tooth root region of the squeezing roll according to FIG. 4.

FIG. 6 shows an alternative schematic contour of a tooth tip region of the squeezing roll.

FIG. 7 shows another modification of the contour of the tooth tip region of the squeezing roll.

FIG. 8 shows another alternative of the contour of the tooth tip region of the squeezing roll.

FIG. 9 shows, with FIGS. 9A through 9I, production phases in a tooth tip region of a roller pair composed of a cylindrical pressure roller and a squeezing roll.

The present embodiments are detailed below with reference to the listed Figures.

### DETAILED DESCRIPTION OF THE EMBODIMENTS

Before explaining the present apparatus in detail, it is to be understood that the apparatus is not limited to the particular embodiments and that it can be practiced or carried out in various ways.

Specific structural and functional details disclosed herein are not to be interpreted as limiting, but merely as a basis of the claims and as a representative basis for teaching persons having ordinary skill in the art to variously employ the present invention.

The present embodiments relate to a squeezing roll or squeezing roller granulator, which has a cylindrical pressure roller and a toothed squeezing roller.

One embodiment of the squeezing roll granulator according to the invention has a cylindrical pressure roller and a toothed squeezing roll. The teeth of the squeezing roll can have tooth flanks that are situated between a tooth root region and a tooth tip region. The tooth root region can have an outer diameter which is smaller than the outer diameter of the tooth tip region. The tooth tip region of the squeezing roll can have three crushing zones with a middle crushing zone.

The zones can define different distances from the cylindrical pressure roller, with a minimum distance in the region of the middle crushing zone. The contour of the tooth flanks and tooth root regions of the squeezing roll in cooperation with the contour of the cylindrical pressure roller can define a maximum cross-section of granulate cushions to be produced. The maximum filling volume can also depend on the width to which the granulate cushions are crushed.

A distinct advantage of the present invention is that with a single squeezing roll rotation, it is able to enclose a large number of filler portions into granulate cushions and seal them in a media-tight fashion, which was not possible with the previously known art. Existing devices merely cut pre-hardened strands into plastic granulates. In addition, the known devices for coextruding multilayer containers fill the containers by means of a filling mandrel, and subsequently closing the containers. Due to this process, known devices are not able to enclose precisely portioned amounts of filler in an outer covering in a media-tight fashion on a mass-production scale.

In an embodiment of the invention, the tooth root region extends from one end of a falling tooth flank to a beginning of a rising tooth flank and the tooth tip region correspondingly extends from one end of a rising tooth flank to a beginning of a falling tooth flank.

In this embodiment, the three crushing zones of the tooth tip region include an incoming crushing zone which is situated toward an infeed side, an outgoing crushing zone which is situated to-ward an outflow side, and a middle crushing zone which is situated between the incoming crushing zone and the outgoing crushing zone. In this embodiment, the incoming and outgoing crushing zones of the teeth are delimited by the tooth flanks. In addition, the incoming crushing zone defines a distance from the pressure roller that decreases in the direction toward the middle crushing zone and the outgoing crushing zone defines a distance from the pressure roller that increases away from the middle crushing zone.

This embodiment advantageous in that, as the surfaces of the pressure roller and the crushing zones of the tooth tip regions of the squeezing roll rotate against one another, the filler of a supplied covering tube filled with filler can be displaced. In this manner, a media-tight welding of the covering material to an incoming sealing seam occurs in the incoming crushing zone and a similar result occurs in outgoing crushing zones of the tooth tip region, where media-tight outgoing sealing seams are produced. The middle crushing zone, which is spaced a minimum distance apart from the pressure roller as the surface of the cylindrical pressure roller rolls against the tooth tip region of the squeezing roll, produces an intended breaking point profile at which adjoining granulate cushions can be disconnected from one another.

In another embodiment of the invention, the squeezing roll granulator has a feeder device for supplying a covering tube with coextruded filler. The squeezing roll granulator is therefore not only able to produce a multi-layered construction of an outer covering through coextrusion of covering materials, but also primarily, for applications in which a single-layer covering tube is coextruded together with a filler, a device is produced that is able to fill granulate cushions and simultaneously seal them in a media-tight fashion by using a roller pair composed of the pressure roller and squeezing roll with a tooth tip region in three crushing zones. In addition, the granulate cushions have portions of the filler that are enclosed by an outer covering composed of the material of the covering tube.

Another advantage of a squeezing roll granulator of this embodiment with an extruded covering tube and the coextruded filler enclosed in the covering tube is that it achieves a mass flow rate and output of granulate cushions that cannot be achieved with conventional systems for producing and filling containers.

In order to further improve the production of sealing seams, in another embodiment of the invention, the tooth tip region can have a beveled incoming edge leading into the incoming crushing zone and a beveled outgoing edge leading from the outgoing crushing zone. These bevels can improve the formation of sealing seams and prevent damage to the extruded covering tube with coextruded filler by the incoming edges or outgoing edges of the crushing zones.

In another embodiment of the invention, the middle crushing zone of the tooth tip region of the squeezing roll has a flattened region serving as an intended breaking point profile. This flattened region, which is spaced a minimum distance from the cylinder surface of the pressure roller, makes it possible to produce an intended breaking point seam of minimal thickness between two granulate cushions that are attached to each other.

In yet another embodiment of the invention, the middle crushing zone of the tooth tip region of the squeezing roll has a step serving as an intended breaking point profile. Such a step, which is spaced a minimum distance apart from the cylinder surface of the pressure roller, functions like a cutting edge so that with an extremely slight load, this intended breaking point seam is suitable for detaching the attached granulate cushions from one another.

In addition, the middle crushing zone of the tooth tip region of the squeezing roll has a rib cross-section protruding out beyond the incoming crushing zone and outgoing crushing zone. Embodiments with such a rib cross-section can reduce the distance from the cylinder surface of the pressure roller so that the middle crushing zone can function as a cutting knife, which makes it possible to detach the granulate cushions from one another with only a slight load on the intended breaking point seam.

In embodiments, the outgoing crushing zone can be longer than the incoming crushing zone. This yields the advantage that the outgoing crush seam is wider or longer than the incoming crush seam, thus significantly reducing the risk of damage to the outgoing sealing seam when a granulate cushion is detached from a subsequent granulate cushion during the crushing phase of the squeezing roll.

In embodiments, the squeezing roll and the pressure roller can have a metal alloy. The cylindrical surface of the pressure roller and the tooth tip regions of the squeezing roll can have wear resistant surfaces, such as surfaces with hard metal coatings, ceramic coatings, or hardened surfaces. A hardening of the surfaces and/or of the tooth tip regions of the squeezing roll can be achieved by means of an inductive hardening process in which the surfaces of the tooth tip regions are heated and then allowed to cool. In other embodiments, it is also possible to achieve an improved hardness by providing hard metal coatings or ceramic coatings, such as nitride or carbide layers on surfaces. The harder the surfaces are embodied to be, the more precisely the different distances of the three crushing zones between the granulate cushions can be controlled.

For the extruded covering tube, it is can be advantageous to use thermoplastic plastics from the group including but not limited to: polyamide (PA), polypropylene (PP), low density polyethylene (LDPE), copolymer (COP), or ethylene-vinyl alcohol copolymer (EVOH), ethylene-vinyl acetate copolymer (EVA), and mixed products thereof. Materials for the extruded covering tube can contain percentages of polyolefin waxes, polyethylene waxes, polypropylene waxes, or fatty acid derivatives, since covering tubes contain not just a single material, but a plurality of materials, which can permit an increased protection from moisture and can be attached to one another by coextrusion to produce a multilayered covering tube.

In another embodiment of the invention, the squeezing roll can be continuously spaced a minimum distance apart from the cylindrical surface of the pressure roller, at least in a subregion of a middle crushing zone of the teeth. In this embodiment, the squeezing roll can be equipped with helical gearing. A helical gearing angle or helix angle α can depend on the outer diameter D of the squeezing roll and the width B of the squeezing roll as well as the number n of teeth distributed around the outer circumference of the squeezing roll.

Because of the requirement to ensure a two-point support between the external gearing of the squeezing roll and the cylindrical surface of the pressure roller, at least a subregion of the squeezing roll gearing can be spaced a minimum distance apart from the cylindrical surface of the pressure roller. For the helical gearing, a helix angle α can be calculated based on arctan of πD/nB (π is the circular constant Pi).

If more than just one tooth tip region is spaced the minimum distance apart from the cylindrical pressure roller on the width B of the squeezing roll, then this can be achieved by means of a factor, preferably such as S, so that a preferred range of the helix angle α lies between a calculated value and a scaled value: arctan (πD/nB)≦α≦S arctan (πD/nB).

In addition, the maximum dimensions of the granulate cushions depend on the geometry of the gearing and the width of the squeezing roll so that for the length 1, a quotient is calculated based on πD/n and for the width b of the granulate cushions on the one hand, a quotient of B/N is definitive, where B is the width of the squeezing roll and N is the number of parallel covering tubes with coextruded filler that are supplied to the squeezing roll, and the outer diameter d of the covering tube with which a width b of the granulate cushion of b≦πd/2 can be achieved.

Another embodiment of the invention relates to a granulation system with a squeezing roll granulator; the granulation system can have an extrusion device for coextruding fillers contained in covering tubes into plastic strands. The granulation system can also have the squeezing roll granulator with a feeder device for supplying the plastic strands to a roller pair composed of a cylindrical pressure roller and a toothed squeezing roll. In addition, the squeezing roll is provided with a drive unit while a collecting device serves to collect the plastic strands that have been portioned into granulate cushions by the roller pair. The granulate cushions can have an outer covering, which is filled with a filler. Finally, a control and regulating device of the granulation system in this embodiment can coordinate the drive unit of the squeezing roll with the extrusion speed of the plastic strands.

Such a granulation system has the advantage that the feeding of the covering tubes with filler in the form of a plastic strand can be adapted to the extrusion speed of an associated extrusion device by means of the drive unit of the squeezing roll in all operating phases. At the outlet of the extrusion device and extending to the intake nip of the roller pair, it is thus possible to provide a relatively short connecting piece, for example in the form of a glide path that adjusts the temperature of the plastic strand.

On such a glide path, it is possible to adjust the temperature of a plurality of parallel-extruded plastic strands to a processing temperature that is required for a compression of the covering tube in order to produce incoming sealing seams in the region of the incoming crushing zone and outgoing sealing seams in the out-going crushing zone. This optimized processing temperature can be produced by introducing temperature adjusted water into the feeder device or through corresponding optimization of the temperature adjustment of the roller pair. It is also possible to convey the parallel extending strands in a supply path through a correspondingly temperature adjusted water bath.

With short supply paths between the extrusion device and the roller pair, a water bath can be used to cool the plastic strands to the required welding temperature during the crushing process. With long supply paths from the extrusion device to the squeezing rolls, it is possible to provide a heating, for example by means of a water bath, to the processing temperature for welding, e.g. 40° C. In addition to a suitable processing temperature, a media tight welding also depends on the contact pressure, the softening temperature of the sleeve material, the material thickness, the exposure time to welding conditions, and other similar considerations.

An embodied use of the squeezing roll granulator, as described above, is the production of granulate cushions with powdered, liquid, highly viscous, or plastically deformable fillers. In this connection, the squeezing roll granulator according to the invention is used for portioning pharmaceutical, medicinal, cosmetic, or adhesive fillers (such as those that must be packed under sterile conditions) into granulate cushions with outer coverings composed of thermoplastically deformable plastics, with or without a percentage of waxes. Adhesive fillers such as hot melt adhesives can be portioned into granulate cushions. As the material for the outer coverings for enclosing the hot-melt adhesive, a material can be used that forms an outer surface of the granulate cushion, which is not adhesive.

The invention will be described in greater detail in conjunction with embodiments that are explained by way of example.

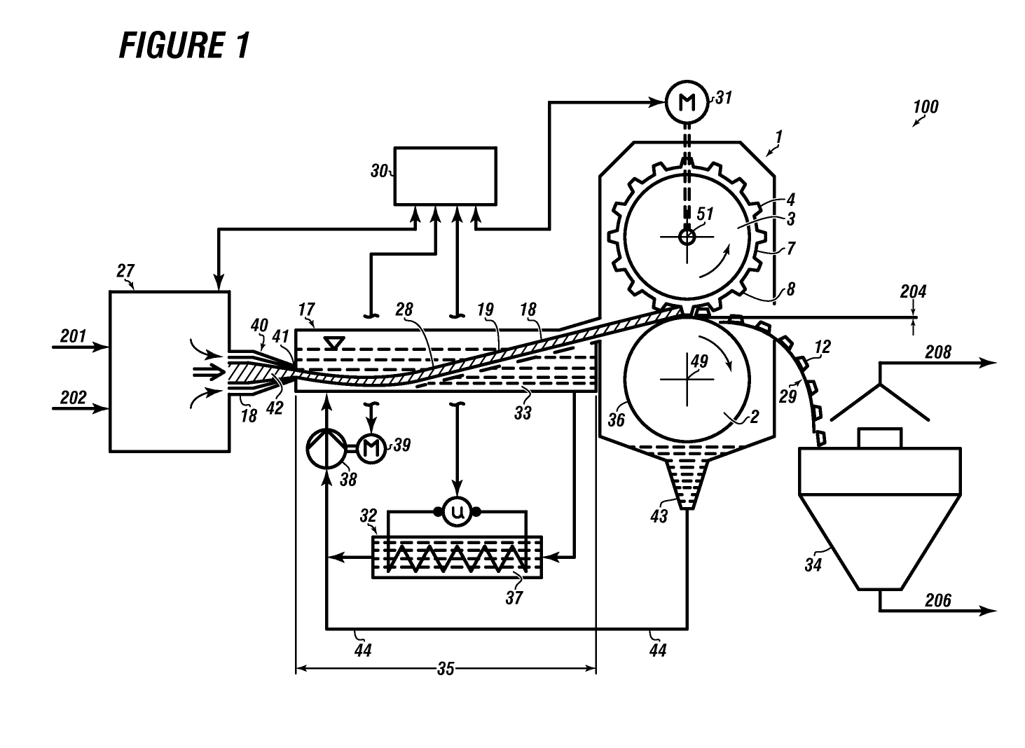

FIG. 1 shows a schematic diagram of a crush granulator in a granulation system for producing granulate cushions.

The granulation system 100 has an extrusion device 27, a supply path 35, and the crush granulator 1. The extrusion device 27 coextrudes a filler 19 in a covering tube 18 into a plastic strand 28. The temperature of this plastic strand 28 is adjusted in a feeder de-vice 17 on a supply path 35 and supplied to the crush granulator 1.

The crush granulator 1 can have a pressure roller 2 and a toothed squeezing roll 3, which can be driven by a drive unit 31. The squeezing roll 3 rolls with its teeth 4 on a cylindrical surface 36 of the pressure roller 2 thereby forming a minimum distance 204 at which granulate cushions 12 composed of a covering tube 18 are portioned with a coextruded filler 19.

The filled granulate cushions 12 can be supplied via a collecting device 29 to a drying device 34, from which the dried and filled granulate cushions 12 are dispensed in the direction of arrow 206 and the moisture-laden air is conveyed out in the direction of arrow 208.

In the feeder device 17 a temperature adjusting device 32 can be situated on the supply path 35 and makes it possible to adjust the temperature of the covering tube 18 by means of a water bath 33 through which the plastic strand 28 is conveyed.

The temperature that the covering tube 18 should assume is used to produce a welded seam in a nip between a tooth tip region 8 of the squeezing roll 3 and the cylindrical surface 36 of the pressure roller 2. The tooth tip region 8 has a middle crushing zone, which has a minimum distance a from the pressure roller 2 and is embodied in such a way that in the middle crushing zone, an intended breaking point profile is formed between media-tight welded seams of the covering tube 18 so that it is possible to cut off the granulate cushions 12 that are produced from an outer covering and a filler.

The temperature adjusting device 32 for a temperature adjusting water bath 33 has a heat exchanger 37, which supplies the necessary cooling or heating energy in order to adjust the temperature of the water bath 33. A pump 38 driven by a motor 39 maintains the circulation between the water bath 33 and the heat exchanger 37.

In order to supply the extrusion device 27 with the material for the covering tube 18, the extrusion device has an inlet 201, while the filler material is supplied via the inlet 202 of the extrusion device 27. The outlet of the extrusion device 27 is provided with a coextrusion nozzle 40, which has an annular gap 41 for extruding a covering tube 18. The filler material 19 can be coextruded in the center 42 of the coextrusion nozzle 40. Such a filler material can be supplied in powdered, liquid, or molten form to coextrusion nozzle 40 via the inlet 202. Preferably, a molten adhesive is coextruded as the filler material 19.

The granulation system 100 shown in FIG. 1 also has a control and regulating unit 30, which coordinates the drive unit 31 of the squeezing roll 3 with the extrusion speed of the extrusion device 27 and simultaneously regulates the temperature adjustment of the plastic strand 28 in the region of the supply path 35 of the feeder device 17.

The temperature-adjusting water can also be supplied via supply lines, not shown, to the squeezing roll 3 in order to control the temperature of the squeezing roll and via a water outlet 43 of the crush granulator 1, can be conveyed back into the temperature-adjusting water circuit via the return line 44.

Instead of the collecting device 29 shown here for the granulate cushions 12 that are supplied by the collecting device 29 to the drying device, the granulate cushions 12 can also be guided in a system of tubes with a flow of water to a water separator, not shown, and then to the drying device 34 shown here.

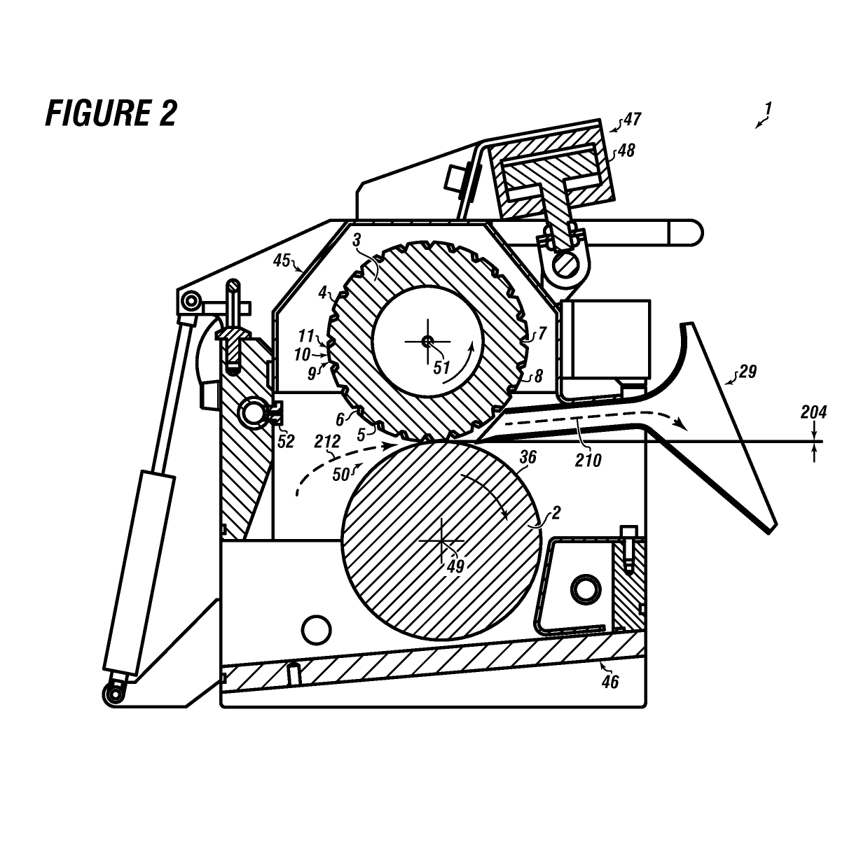

FIG. 2 shows a schematic cross-section through a section of a crush granulator.

The crush granulator 1 can have two housing halves 45 and 46, with an upper housing half 45 arranged in pivoting fashion relative to a lower housing half 46. The lower housing half 46 here can be positioned on a machine frame. The cylindrical pressure roller 2 is supported in rotary fashion in the lower housing half 46 while the driven squeezing roll 3 provided with teeth 4 is contained in the upper housing half 45.

In addition, the upper housing half 45 has a pressing mechanism 47 with which, in the closed state of the housing, the squeezing roll 3 can be varied relative to the pressure roller 2 by changing a minimum distance 204 or by changing a contact pressure between the cylindrical surface 36 of the pressure roller 2 and the tooth tip regions 8 of the squeezing roll 3 by means of a hydraulic or pneumatic cylinder 48. By means of the pressing mechanism 47, the crushing regions and their possible crushing thickness can be adapted to the respective material of the covering tube for an optimal production of sealing seams and intended breaking point profiles. Instead of the hydraulic or pneumatic cylinder 48, an electromechanical actuator can also be used.

The axes 49 and 51 of the pressure roller 2 and squeezing roll 3 can be supported in an axially parallel fashion in the housing halves 45 and 46. The squeezing roll 3 can have teeth 4 that have a tooth root region 7 and a tooth tip region 8. In this embodiment, tooth tip region 8 has three crushing zones 9, 10 and 11, as shown in detail in the rest of the figures. The crushing zones 9, 10 and 11 have an incoming crushing zone 9, a middle crushing zone 10, and an outgoing crushing zone 11.

The middle crushing zone 10 is situated between the incoming crushing zone 9 and the outgoing crushing zone 11 and defines the minimum distance, a between the squeezing roll 3 and the pressure roller 2 with a static pressing mechanism 47. This minimum distance depends on the corresponding contact pressure between the middle crushing zone 10 and the cylindrical surface of the pressure roller, the processing temperature, the material properties such as material thickness and plasticity at the processing temperature, and the like.

This cross-section through the crush granulator 1 also shows a collecting hopper of the collecting device 29, which conveys the granulate cushions shown in FIG. 1 in the direction of arrow 210 when in the direction of arrow 212, corresponding plastic strands composed of a covering tube and a filler are supplied to the roller pair 50 in the nip region. In addition, the lower housing half 46 can contain a water jet nozzle 52 that aims temperature-adjusted water at the crushing nip in order to assist the welding process in the production of sealing seams.

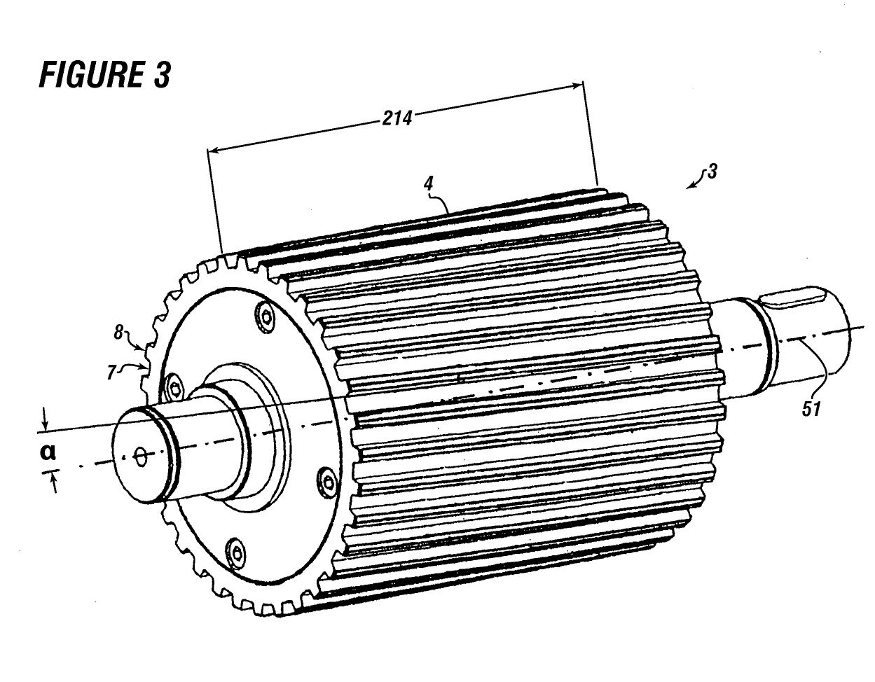

FIG. 3 shows a schematic perspective view of a squeezing roll of the crush granulator.

FIG. 3 shows a schematic perspective view of a squeezing roll 3 of the crush granulator shown in FIGS. 1 and 2. The width 214 of the squeezing roll 3 can be dimensioned so that a plurality of plastic strands can be simultaneously processed in parallel to produce granulate cushions. The gearing 4 of the squeezing roll 3 can be embodied in the form of helical gearing with a so-called helix angle α relative to the orientation of the squeezing roll axis 51.

This helical gearing angle or helix angle α can be dimensioned so that at least one tooth tip region 8 of the n tooth tip regions 8 of the squeezing roll 3 can roll against the cylindrical surface 36 of the pressure roller 2 across the width 214 of the squeezing roll 3. This yields a helical gearing angle or helix angle α between: arctan πD/nB≦α≦S arctan πD/nB, where D is the outer diameter of the squeezing roll 3, B is the width of the squeezing roll 3, and n is the number of teeth 4 of the squeezing roll 3 distributed over its outer circumference.

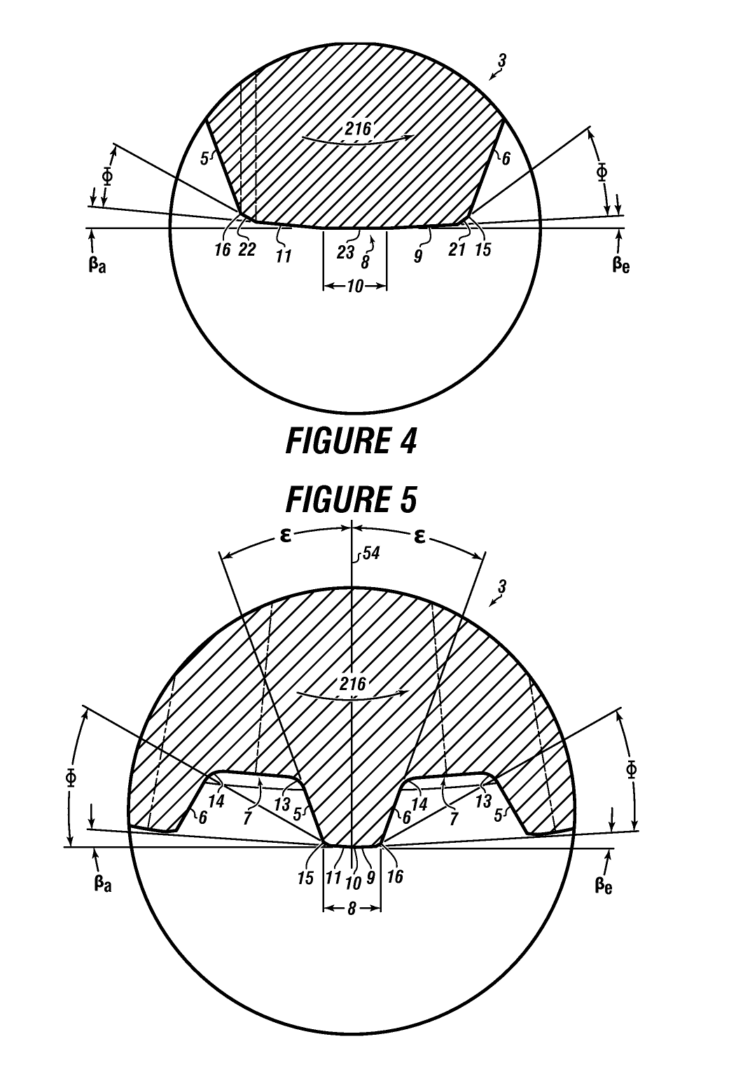

FIG. 4 shows a schematic contour of a tooth tip region of a squeezing roll;

The direction of the arrow 216 depicts the rotation direction of the squeezing roll 3. The tooth tip region 8 lies between a rising tooth flank 6 that rises in the rotation direction 216 and a tooth flank 5 that falls in the rotation direction 216, both belonging to the teeth 4 of the squeezing roll 3. The incoming crushing zone 9 begins with an end 15 of the rising tooth flank 6, whose end 15 has a beveled incoming edge 21 with a bevel angle Φe. The bevel angle Φe can be from 45 degrees to 15 degrees. The outgoing crushing zone 11 ends at a beginning 16 of a falling tooth flank 5; the beginning 16 has a beveled outgoing edge 22 with a bevel angle Φa of from 45 degrees to 15 degrees, where Φe and Φa can have different values.

The beveled incoming edges 21 and outgoing edges 22 provide for a gentle crush welding of the covering tube during the portioning thereof. Between the incoming crushing zone 9 and outgoing crushing zone 11, there is a middle crushing zone 10 whose flattened region 23 defines a minimum distance from the pressure roller throughout the entire region of the middle crushing zone 10. The incoming crushing zone 9 is embodied so that it extends from the incoming edge 21 to the middle crushing zone 10 so that the distance from the pressure roller gradually decreases. This is achieved in that in this embodiment of the invention, the rising angle βe of the incoming edge 21 until the middle crushing zone 10 is from 2 degrees to 8 degrees, and can be from 3 degrees to 5 degrees, for the incoming crushing zone 9. In analogous fashion, starting from the middle crushing zone 10, the distance from the pressure roller in-creases in the outgoing crushing zone 11, for which in this embodiment, the same value is provided for the falling angle βa. In this embodiment, βa=βe, but this is not absolutely necessary.

During the portioning of the covering tube with coextruded filler, the middle crushing zone 10 with its minimum distance a from the pressure roller constitutes a filler free intended breaking point profile, which can be fractions of a millimeter or several millimeters thick, depending on the adjustment of the pressing mechanism 47 shown in FIG. 2.

FIG. 5 shows a schematic contour of a tooth root region of the squeezing roll according to FIG. 4.

FIG. 5 shows a schematic contour of the teeth 4 of the squeezing roller 3 in the vicinity of tooth root regions 7. With a rotation direction extending in the direction of arrow 216, such a tooth root region 7 extends from the end 13 of a falling tooth flank 5 to the beginning 14 of a rising tooth flank 6. The tooth root region 7a, 7b, and 7c can have a length of from several millimeters to a few centimeters and lies between a falling tooth flank and a rising tooth flank, 5 and 6, respectively. In addition, a radius of 1 mm to 3 mm is provided in the region of the end 13 of the falling tooth flank 5 and in the region of the beginning 14 of the rising tooth flank 6 in order to avoid microcracks due to the notch effect of transitions between the tooth flanks 5 and 6 and the tooth root region 7.

With the center line 54 of the tooth tip region 8, the tooth flanks form a flank angle ε, which can lie from 10 degrees to 35 degrees, and can be from 15 degrees to 25 degrees in embodiments. The contour of the tooth root region 7a, 7b, and 7c with the contour of the rising and falling tooth flanks 5 and 6, respectively, in cooperation with the cylindrical surface of the pressure roller, constitutes the maximum possible cross-section of a granulate cushion that the crush granulator can pro-duce from an outer covering that is filled with a filler material.

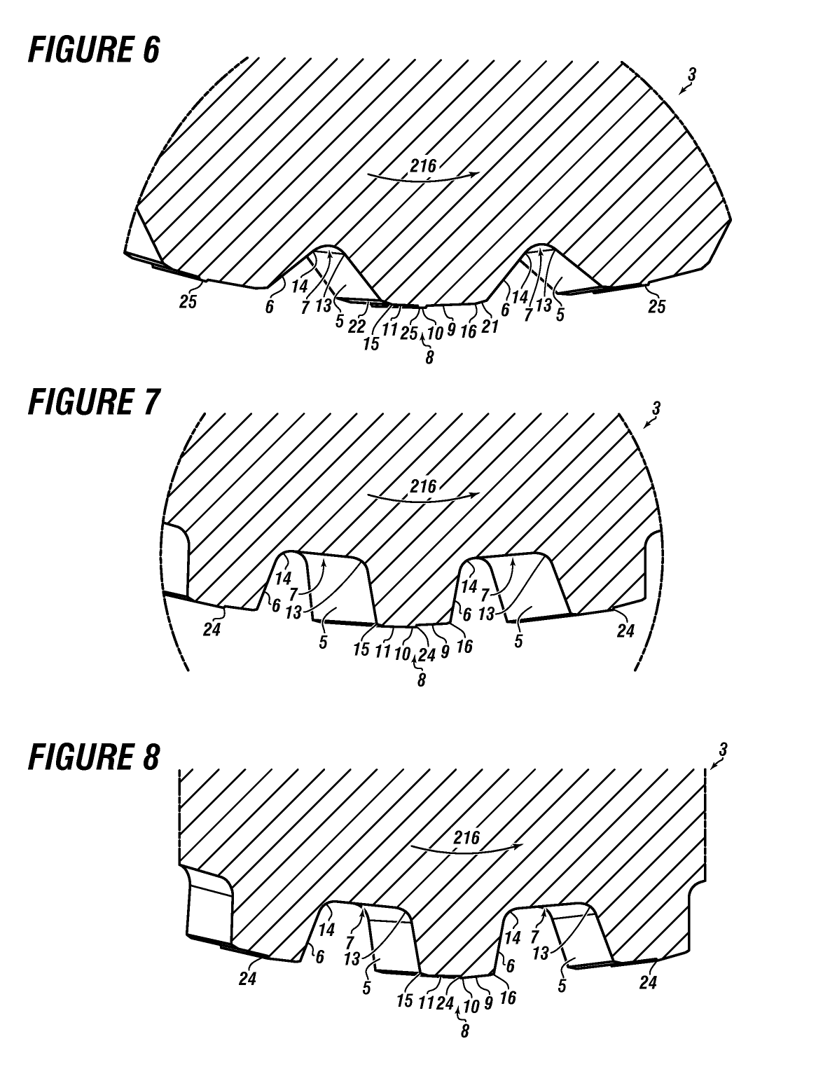

The middle crushing zone 10, which in this embodiment shown in FIGS. 4 and 5 can be spaced uniformly apart from the pressure roller, will now be varied in the different embodiments that are shown in FIGS. 6 through 8.

FIG. 6 shows an alternative schematic contour of a tooth tip region of the squeezing roll.

Components with the same functions as those in FIGS. 4 and 5 are provided with the same reference numerals and are not discussed in particular detail.

The difference from the embodiment according to FIGS. 4 and 5 lies in the fact that in FIG. 6, the middle crushing zone has a rib cross-section 25 that protrudes beyond the level of the incoming crushing zone 9 and outgoing crushing zone 11 and thus defines a minimum distance from the cylindrical surface of the pressure roller. As before, this rib cross-section 25 of the middle crushing zone can crimp an intended breaking point profile into the covering tube or can even be embodied so that it produces a cut-ting blade that detaches the granulate cushions from one another.

FIG. 7 shows another modification of the contour of the tooth tip region of the squeezing roll.

While both a slightly modified incoming crushing zone 9 and outgoing crushing zone 11 are provided, the middle crushing zone 10 of the tooth tip region 8 is pro-vided with a sharp step 24 at the transition from the incoming crushing zone 9 to the middle crushing zone 10. This sharp step 24 is likewise able to achieve anywhere from a highly effective in-tended breaking point profile to a shearing-off of the granulate cushions. In this embodiment, the outgoing crushing zone 11 can be elongated in comparison to the incoming crushing zone 9.

FIG. 8 shows another alternative of the contour of the tooth tip region of the squeezing roll.

This is an alternative contour of the tooth tip region 8abc of the squeezing roll 3 in which, in a fashion similar to the one shown in FIG. 7, a sharp step 24 is provided in the middle crushing zone 10, but with the difference from the embodiment shown in FIG. 7 being that this step 24 is situated at the transition from the middle crushing zone 10 to the outgoing crushing zone 11.

In this embodiment, the incoming crushing zone 9 can be elongated relative to the outgoing crushing zone 11.

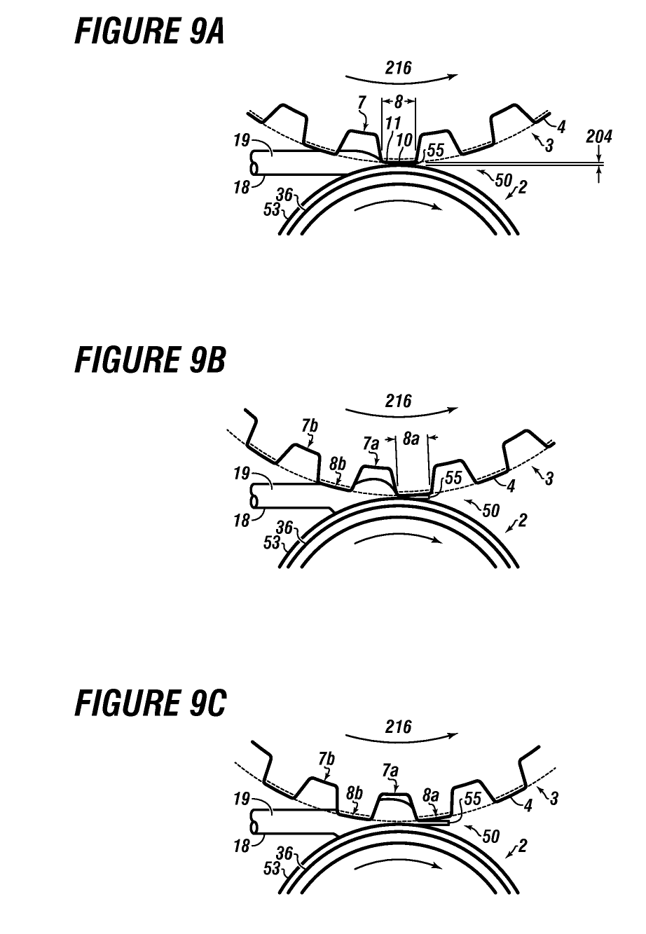

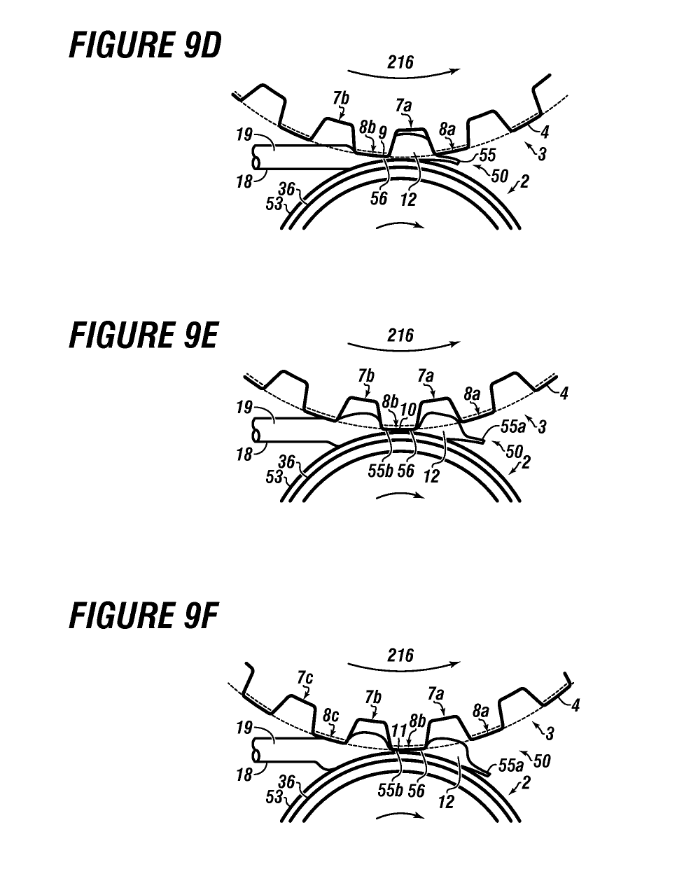

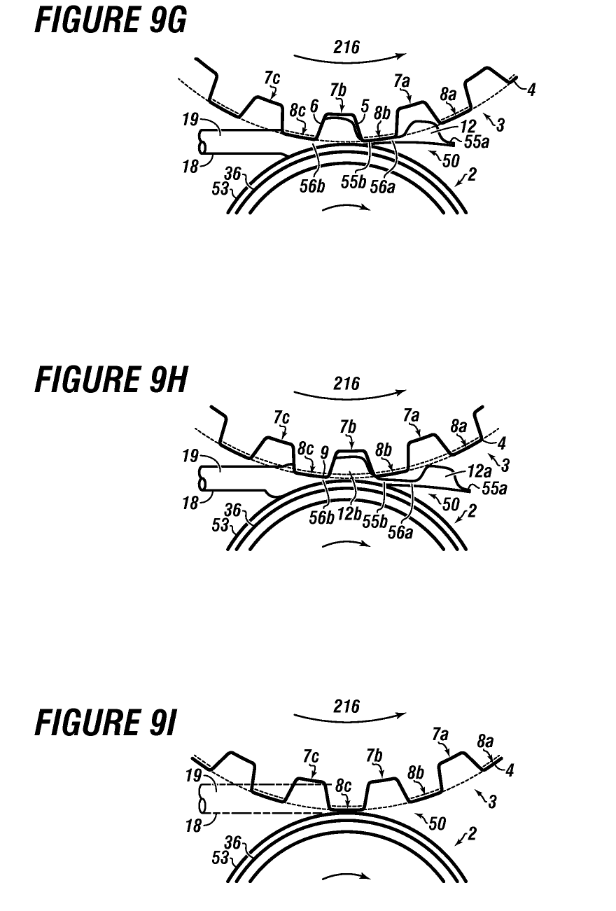

FIG. 9 shows, with FIGS. 9A through 9I, production phases in a tooth tip region of a roller pair composed of a cylindrical pressure roller and a squeezing roll.

FIG. 9 shows, with FIGS. 9A through 9I, production phases in a tooth tip region 8 of a roller pair 50 composed of a pressure roller 2 and a squeezing roll 3. The pressure roller 2 has a cylindrical surface 36, which has a hardened metal alloy or a hard metal coating or ceramic coating 53. The tooth tip regions 8a, 8b, and 8c of the squeezing roll 3 are preferably surface-hardened by means of an inductive hardening process.

The nip that is formed by a minimum distance, a between the pressure roller 2 and the squeezing roll 3, as shown in FIG. 9A, draws in the beginning of a covering tube 18 with a filler 19, thus forming a first media-tight incoming crush seam 55 of a granulate cushion that is to be produced. In this case, the covering tube 18 with the filler 19 in FIG. 9B is grasped by a subsequent tooth tip region 8a of the teeth 4 of the squeezing roll 3.

As shown in FIG. 9C, the covering tube 18 is increasingly com-pressed, thus pressing the filler 19 into the cavity between the cylindrical surface 36 of the pressure roller 2 and the tooth root region 7 of the squeezing roll 3, forming an outer covering that encloses the filler 19. In FIG. 9D, the incoming crushing zone 9 of the subsequent tooth tip region 8b is reached and a first end crush seam 56 for a first granulate cushion 12 is produced in the incoming crushing zone 9.

In FIG. 9E, the minimum distance a, as shown in FIG. 9A between the subsequent tooth tip region 8a and the cylindrical surface 36 of the pressure roller 2 is reached by the middle crushing zone 10 of the tooth tip region 8b, thus producing an intended breaking point profile. As the squeezing roll 3 rotates farther in the direction of the arrow C, the tooth tip region 8b travels into the out-going crushing zone 11, which then in FIG. 9F, produces a media tight second incoming crush seam 55b for a subsequent granulate cushion 12 by means of welding.

As the squeezing roll 3 rotates farther in the direction of arrow C, the phase shown in FIG. 9G is reached in which, between the cylindrical surface 36 of the pressure roller 2 and the contour that is composed of the tooth flanks 5 and 6 and the tooth root region 7b of the squeezing roll 3, the contour of the granulate cushion 12 is then prepared, which fills almost the entire space between the cylindrical surface of the pressure roller 2 and the tooth root region 7a of the squeezing roll 3.

As shown in FIG. 9H, as soon as the incoming crushing zone 9 of the tooth tip region 8c of the squeezing roll 3 reduces the distance between the cylindrical surface 36 of the pressure roller 2 and the tooth tip region 8c of the squeezing roll 3 to a welding distance, another end crush seam 56b of the subsequent granulate cushion 12 is welded.

Finally in FIG. 9I, the initial state shown in FIG. 9A is reached with a subsequent tooth tip region 8c. As a result, it is now possible, synchronized with the rotation speed of the squeezing roll 3 and the extrusion speed of the plastic strand, to carry out a continuous, large-scale, and sterile production of portioned granulate cushions 12 composed of a covering material and a filler, without an infiltration of microorganisms.

Since the width of the granulate cushions 12 is less than the width B of the squeezing roll 3, shown as reference numeral 214 in FIG. 3, a plurality of covering tubes 18, namely up to N covering tubes, where N≦2B/πd, can be positioned parallel to one another at the same time and/or parallel to the squeezing roll 3, where d is the outer diameter of the covering tube. It is thus possible to significantly multiply the output of the crush granulator according to the invention.

Although at least exemplary embodiments have been demonstrated in the above description, various changes and modifications can be carried out. The embodiments mentioned are only examples and are not provided to restrict the scope of validity, the applicability, or the configuration of the squeezing roll granulator in any way. Instead, the above description provides the person skilled in the art with a plan for implementing at least one exemplary embodiment of the squeezing roll granulator. Numerous changes in the function and design of the squeezing roll granulator can be made in components of the squeezing roll granulator described in the exemplary embodiments without departing from the scope of protection of the attached claims and their legal equivalents.

While the invention has been described with emphasis on the embodiments, it should be understood that within the scope of the appended claims, the embodiments might be practiced other than as specifically described herein.

What is claimed is:

1. A squeeze roller granulator that comprising:
a) a cylindrical pressure roller; and
b) a toothed squeeze roller, wherein a gearing of the squeeze roller comprises:
i) a tooth flank situated between a tooth root region and a tooth tip region, wherein the tooth root region has a tooth root outer diameter that is smaller than a tooth tip outer diameter; and
ii) an incoming crushing zone, an outgoing crushing zone, and a middle crushing zone disposed in the tooth tip region, wherein the incoming crushing zone, the outgoing crushing zone, and the middle crushing zone define different distances from the cylindrical pressure roller, and further wherein the middle crushing zone is a smaller distance from the cylindrical pressure roller than the incoming crushing zone and outgoing crushing zone; and
wherein a contour of the tooth flank and the tooth root region in cooperation with a contour of the cylindrical pressure roller defines a maximum cross-section of each of a plurality of granulate cushions to be formed.

2. The squeeze roller granulator of claim 1, wherein the tooth root region extends from an end of a falling tooth flank to a beginning of a rising tooth flank and the tooth tip region extends from an end of a rising tooth flank to a beginning of a falling tooth flank, wherein the incoming crushing zone is situated toward an infeed side, the outgoing crushing zone is situated toward an outflow side, and the middle crushing zone is situated between the incoming crushing zone and outgoing crushing zone, and further wherein the incoming crushing zone and outgoing crushing zone of the teeth are delimited by the tooth flanks, and further wherein the incoming crushing zone defines a distance from the cylindrical pressure roller that decreases toward the middle crushing zone and the outgoing crushing zone defines a distance from the cylindrical pressure roller that increases leading away from the middle crushing zone.

3. The squeeze roller granulator of claim 1, wherein the squeeze roller granulator comprises a feeder device for feeding a covering tube with coextruded filler, and each of the plurality of granulate cushions to be formed contains portions of the coextruded filler and is enclosed by an outer covering composed of the material of the covering tube.

4. The squeeze roller granulator of claim 1, wherein the incoming crushing zone produces an incoming sealing seam of each of the plurality of granulate cushions, the outgoing crushing zone produces an outgoing sealing seam of each of the plurality of granulate cushions, and the middle crushing zone produces an intended breaking point profile between each of the plurality of granulate cushions.

5. The squeeze roller granulator of claim 1, wherein the tooth tip region has a beveled incoming edge of the incoming crushing zone and a beveled outgoing edge of the outgoing crushing zone.

6. The squeeze roller granulator of claim 1, wherein the middle crushing zone has a flattened region serving as an intended breaking point profile.

7. The squeeze roller granulator of claim 1, wherein the middle crushing zone has a step serving as an intended breaking point profile.

8. The squeeze roller granulator of claim 1, wherein the middle crushing zone has a rib cross-section that protrudes beyond the incoming crushing zone and the outgoing crushing zone.

9. The squeeze roller granulator of claim 1, wherein the outgoing crushing zone is longer than the incoming crushing zone.

10. The squeeze roller granulator of claim 1, wherein the squeeze roller and the pressure roller comprise a metal alloy and the cylindrical surface of the pressure roller and the tooth tip regions of the squeeze roller have wear-resistant surfaces.

11. The squeeze roller granulator of claim 1, wherein the covering tube contains thermoplastic plastics from the group comprising at least one of:
a) polyamide (PA);
b) polypropylene (PP);
c) low-density polyethylene (LDPE);
d) copolymer (COP);
e) ethylene-vinyl alcohol copolymer (EVOH); and
f) ethylene-vinyl acetate copolymer (EVA); and
wherein mixed products thereof comprise polyolefin waxes, polyethylene waxes, polypropylene waxes, or fatty acid derivatives.

12. The squeeze roller granulator of claim 1, wherein the squeeze roller has a helical gearing with helical gearing angle α between arctan πD/nB≦α≦S arctan πD/nB, wherein D is the outer diameter of the squeeze roller, B is the width of the squeeze roller, π is the mathematical constant Pi, and n is the number of teeth distributed over the outer circumference of the squeeze roller.

13. The squeeze roller granulator of claim 1, wherein a granulate cushion has a length 1 of 1≦πD/n, wherein π is the mathematical constant Pi, n is the number of teeth distributed over the outer circumference of the squeeze roller, and D is the outer diameter of the squeeze roller,

14. The squeeze roller granulator of claim 1, wherein a granulate cushion has a width b of b≦B/N, wherein B is the width of the squeeze roller and N is a number of parallel covering tubes with coextruded filler that are supplied to the squeeze roller, such that N≦2B/πd, wherein π is the mathematical constant Pi, and d is the outer diameter of the covering tube.

15. The squeeze roller granulator of claim 1, further comprising an extrusion device for coextruding fillers contained in covering tubes into plastic strands, wherein the extrusion device comprises a feeder device for supplying the plastic strands to a roller pair composed of the cylindrical pressure roller and the squeeze roller, a drive unit of the squeeze roller, and a collecting device for collecting the plastic strands that have been portioned into granulate cushions, wherein the granulate cushions comprise an outer covering and a coextruded filler, and further wherein a control and regulating device of the squeeze roller granulator coordinates the drive unit of the squeeze roller with the extrusion speed of the plastic strands.

16. The squeeze roller granulator of claim 1, wherein the squeeze roller granulator produces granulate cushions with powdered, liquid, highly viscous, or plastically deformable fillers.

17. The squeeze roller granulator of claim 1, wherein the squeeze roller granulator portions pharmaceutical, medicinal, cosmetic, adhesive, or sterile-packed fillers into granulate cushions with an outer covering.
